(19) United States
(12) Patent Application Publication
(10) Pub. No.: US 2024/0273823 A1
(43) Pub. Date: Aug. 15, 2024

(54) INTERACTION METHOD AND APPARATUS FOR VIRTUAL OBJECT, COMPUTER DEVICE, AND STORAGE MEDIUM

(71) Applicant: Tencent Technology (Shenzhen) Company Limited, Shenzhen (CN)

(72) Inventor: Fenlin CAI, Shenzhen (CN)

(21) Appl. No.: 18/642,809

(22) Filed: Apr. 22, 2024

Related U.S. Application Data
(63) Continuation of application No. PCT/CN2023/094589, filed on May 18, 2023.

(30) Foreign Application Priority Data
Jul. 25, 2022 (CN) 2022/10877788.9

(51) Int. Cl. G06T 17/00; A63F 13/577; A63F 13/58

(52) U.S. Cl. CPC G06T 17/00; A63F 13/577; A63F 13/58

(57) ABSTRACT

This application provides an interaction method for controlling a virtual object performed by a computer device. The method includes: displaying a virtual scene comprising a virtual object and multiple polluted regions, each polluted region having a pollution source at a predefined location within the polluted region; after the virtual object moves into a target polluted region, determining a region impact value of a position of the virtual object based on a distance between the virtual object and the target pollution source; when the distance between the virtual object and the target pollution source is not greater than a distance threshold, converting the target pollution source into a target object; and when the virtual object defeats the target object, converting the target polluted region into a target purified region and reducing an impact exerted by a current existing pollution source on the target purified region by the region impact value.

### CROSS-REFERENCE TO RELATED APPLICATIONS

This application is a continuation application of PCT Patent Application No. PCT/CN2023/094589, entitled “INTERACTION METHOD AND APPARATUS FOR VIRTUAL OBJECT, COMPUTER DEVICE, AND STORAGE MEDIUM” filed on May 16, 2023, which claims priority to Chinese Patent Application No. 202210877788.9, entitled “INTERACTION METHOD AND APPARATUS FOR VIRTUAL OBJECT, COMPUTER DEVICE, AND STORAGE MEDIUM” filed on Jul. 25, 2022, all of which is incorporated herein by reference in its entirety.

### FIELD OF THE TECHNOLOGY

This application relates to the field of computer technologies, and in particular, to an interaction method and apparatus for a virtual object, a computer device, and a storage medium.

### BACKGROUND OF THE DISCLOSURE

With the development of computer technologies, increasing types of games can be played on terminals. An open-world game is one of the games. In this game, a virtual object may be controlled through a terminal to freely explore a virtual scene of this type of game, thereby completing a battle goal of a virtual battle.

### SUMMARY

Embodiments of this application provide an interaction method and apparatus for a virtual object, a computer device, and a storage medium, to enrich content of a virtual battle, increase manners of interaction between a virtual object and an object of the virtual battle, and improve human-machine interaction efficiency. The technical solutions are as follows.

According to an aspect, an interaction method for controlling a virtual object is provided. The method is performed by a computer device, and includes:
displaying a virtual scene, the virtual scene comprising a virtual object and a plurality of polluted regions, each of the polluted regions comprising a pollution source at a predefined location within the polluted region;
after the virtual object moves into a target polluted region of the plurality of polluted regions, determining a region impact value of a position of the virtual object based on a distance between the virtual object and the target pollution source;
when the distance between the virtual object and the target pollution source is not greater than a distance threshold, converting the target pollution source into a target object, wherein the target object is movable in the target polluted region; and
when the virtual object defeats the target object, converting the target polluted region into a target purified region and reducing an impact exerted by a current existing pollution source on the target purified region by the region impact value.

According to another aspect, a computer device is provided. The computer device includes a processor and a memory. The memory is configured to store at least one computer program. The at least one computer program is loaded and executed by the processor and causes the computer device to implement the interaction method for controlling a virtual object in the embodiments of this application.

According to another aspect, a non-transitory computer-readable storage medium is provided. The non-transitory computer-readable storage medium stores at least one computer program. The at least one computer program is loaded and executed by a processor of a computer device and causes the computer device to implement the interaction method for controlling a virtual object in the embodiments of this application.

Embodiments of this application provide an interaction solution for a virtual object. The plurality of polluted regions are arranged in the virtual scene, and the region impact value of the position of the virtual object is displayed based on the distance between the virtual object and the target pollution source. The region impact value can reflect the degree of pollution caused by the target pollution source to the position of the virtual object. Because the target pollution source causes different degrees of pollution to different positions, the virtual object can be guided to quickly find the target pollution source. As the distance between the virtual object and the target pollution source continuously decreases, the target pollution source is converted to the target object when the distance between the virtual object and the target pollution source is not greater than the distance threshold, so that the virtual object can interact with the target object. By defeating the target object, the target polluted region is displayed as the target purified region. Since the target purified region can reduce the region impact value exerted by the current existing pollution source on the target purified region, the degree of pollution to the position of the virtual object can be reduced. In this way, content of a virtual battle is enriched, manners of interaction between a virtual object and an object of the virtual battle are increased, and human-machine interaction efficiency.

### BRIEF DESCRIPTION OF THE DRAWINGS

FIG. 1 is a schematic diagram of an implementation environment of an interaction method for controlling a virtual object according to an embodiment of this application.

FIG. 2 is a flowchart of an interaction method for controlling a virtual object according to an embodiment of this application.

FIG. 3 is a flowchart of another interaction method for controlling a virtual object according to an embodiment of this application.

FIG. 4 is a schematic diagram of a reference region according to an embodiment of this application.

FIG. 5 is a schematic diagram of a region impact value according to an embodiment of this application.

FIG. 6 is a schematic diagram of conversion between a target pollution source and a target object according to an embodiment of this application.

FIG. 7 is a flowchart of conversion between a target pollution source and a target object according to an embodiment of this application.

FIG. 8 is a schematic diagram of first prompt information according to an embodiment of this application.

FIG. 9 is a schematic diagram of removing a target object according to an embodiment of this application.

FIG. 10 is a flowchart of displaying a target purified region according to an embodiment of this application.

FIG. 11 is a schematic structural diagram of an interaction apparatus for a virtual object according to an embodiment of this application.

FIG. 12 is a schematic structural diagram of another interaction apparatus for a virtual object according to an embodiment of this application.

FIG. 13 is a structural block diagram of a terminal according to an embodiment of this application.

### DESCRIPTION OF EMBODIMENTS

To make objectives, technical solutions, and advantages of this application clearer, implementations of this application are further described in detail below with reference to drawings.

In this application, words such as “first” and “second” are used for distinguishing between same or similar items with substantially same effects and functions. No logical or temporal dependency exists among “first”, “second”, and “nh”, and a quantity and an execution order are not limited.

In this application, “at least one” means one or more, and “a plurality of” means two or more.

Information (including but not limited to user equipment information and user personal information), data (including but not limited to data for analysis, stored data, and displayed data), and signals involved in this application are all authorized by users or fully authorized by all parties, and collection, use, and processing of relevant data need to comply with relevant laws, regulations, and standards of relevant countries and regions. For example, region impact values of a virtual object involved in this application are all obtained under full authorization.

For ease of understanding, terms involved in this application are explained below.

Virtual scene: It is a virtual scene displayed (or provided) when an application runs in a terminal. The virtual scene may be a simulated environment of the real world, or may be a semi-simulated and semi-fabricated virtual scene, or may be a completely fabricated virtual scene. The virtual scene may be a two-dimensional virtual scene, a 2.5-dimensional virtual scene, or a three-dimensional virtual scene. For example, the virtual scene may include sky, lands, oceans, and the like. The lands may include environmental elements such as deserts and cities. A user may control a virtual object to move in the virtual scene.

Virtual object: It is a movable object in a virtual world. The movable object may be at least one of a virtual character, a virtual animal, and a cartoon character. In some embodiments, when the virtual world is a three-dimensional virtual world, the virtual object is a three-dimensional model. Each virtual object has a shape and a volume in the three-dimensional virtual world, and occupies a partial space in the three-dimensional virtual world. In some embodiments, the virtual object is a three-dimensional role constructed based on a three-dimensional human bone technology. The virtual object realizes different external appearances by wearing different skins. In some embodiments, the virtual object may be realized by using a 2.5-dimensional model or 2-dimensional model, which is not limited in embodiments of this application.

Shooting game: It includes all games including long-range attack with firearms such as a first-person shooting game (FPS) and a third-person shooting game, but is not limited thereto.

Third-person perspective: It is a perspective of a virtual lens in a virtual scene at a specific distance behind a virtual object, at which the virtual object and all battle elements in a surrounding environment can be seen from a screen.

Open world: It is a completely free and open virtual scene in a game, in which a virtual object can freely explore any direction, and distances among boundaries of all directions are very large.

An interaction method for controlling a virtual object provided in the embodiments of this application may be performed by a computer device. In some embodiments, the computer device may be a terminal or a server. An implementation environment of the interaction method for controlling a virtual object provided in the embodiments of this application by using an example in which the computer device is a terminal. FIG. 1 is a schematic diagram of an implementation environment of an interaction method for controlling a virtual object according to an embodiment of this application. As shown in FIG. 1, the implementation environment may include a terminal 101 and a server 102. The terminal 101 and the server 102 may be directly or indirectly connected through wired or wireless communication, which is not limited in this application.

In some embodiments, the terminal 101 may be a smart phone, a tablet computer, a notebook computer, a desktop computer, a smart speaker, a smart watch, a smart voice interactive device, a smart household appliance, or an on-board terminal. An application supporting a virtual scene is installed on the terminal 101. The application may be any one of an FPS game, a third-person shooting game, a multiplayer online battle arena (MOBA) game, a virtual reality application, a three-dimensional map program, or a multiplayer shootout survival game. The terminal 101 can display a virtual scene of a virtual battle. The terminal 101 can further manipulate a virtual object located in the virtual scene to perform activities. The activities include but are not limited to at least one of adjusting a body posture, crawling, walking, running, riding, jumping, driving, pickup, and throwing. Exemplarily, the virtual object is a virtual character, such as a simulated character or a cartoon character.

A person skilled in the art may know that there may be more or fewer terminals. For example, there may be only one terminal, or dozens or hundreds of terminals, or more terminals. A quantity of terminals and a device type are not limited in the embodiments of this application.

In some embodiments, the server 102 may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform. The server 102 is configured to provide a background service for the application supporting the virtual scene. In some embodiments, the server 102 is in charge of primary computing works, and the terminal 101 is in charge of secondary computing works. Alternatively, the server 102 is in charge of the secondary computing works, and the terminal 101 is in charge of the primary computing works. Alternatively, the server 102 and the terminal 101 perform collaborative computing based on a distributed computing architecture.

In the related art, a virtual object may be controlled through a terminal for free exploration in a virtual scene of this type of game, thereby completing a battle goal of a virtual battle. The virtual scene has a high degree of freedom. The virtual object may quickly find and complete the battle goal, which results an excessively short time of the virtual battle. Alternatively, the virtual object cannot find the battle goal after a long time, and therefore performs blind actions in the virtual scene, which results in an excessively long time of the virtual battle. It may be learned from the above that, due to a single playing mode of the foregoing game, the virtual battle ends excessively quickly or cannot end after a long time, resulting in human-machine interaction efficiency.

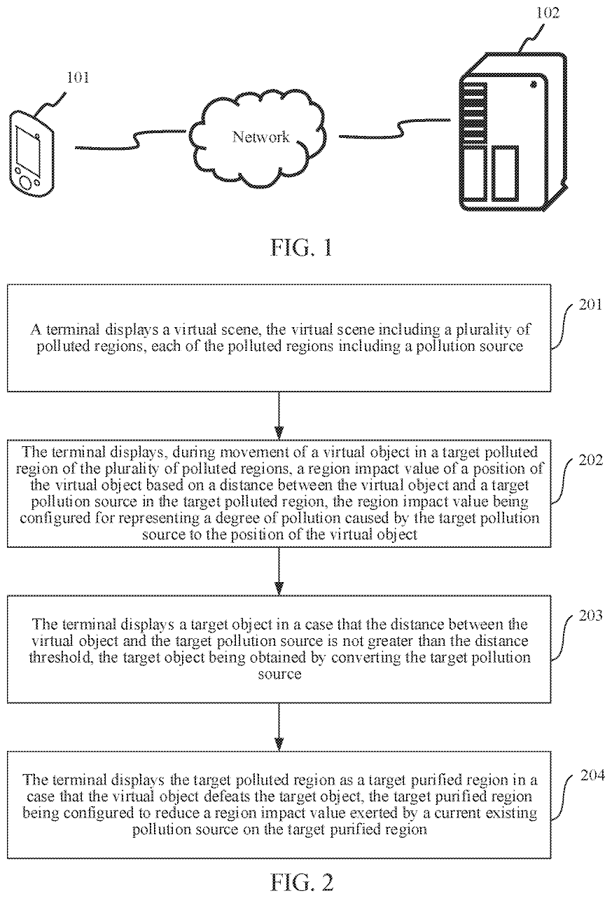

FIG. 2 is a flowchart of an interaction method for controlling a virtual object according to an embodiment of this application. Referring to FIG. 2, in this embodiment of this application, a description is provided by using an example in which a terminal performs the method. The interaction method for controlling a virtual object includes the following operations:
201: The terminal displays a virtual scene, the virtual scene including a plurality of polluted regions, each of the polluted regions including a pollution source.

In this embodiment of this application, the virtual scene is a three-dimensional space. The plurality of polluted regions included in the virtual scene are three-dimensional space regions. Because the virtual object usually moves on a ground in the virtual scene, the polluted region described in this embodiment of this application is in a shape of a projection of the three-dimensional space region on the ground. Correspondingly, the polluted region may be in a circular, square, polygonal, or irregular shape, which is not limited in this embodiment of this application. The plurality of polluted regions may or may not have overlapping parts. Positions of the plurality of polluted regions in the virtual scene are not limited in this embodiment of this application. A pollution source exists in each polluted region. A diffusion range of pollution caused by the pollution source is the polluted region where the pollution source is located.
202: The terminal displays, during movement of the virtual object in a target polluted region of the plurality of polluted regions, a region impact value of a position of the virtual object based on a distance between the virtual object and a target pollution source in the target polluted region, the region impact value being configured for representing a degree of pollution caused by the target pollution source to the position of the virtual object.

In this embodiment of this application, the virtual object is a virtual object controlled by the terminal. The terminal can control the virtual object to freely perform activities in the virtual scene, for example, controls the virtual object to enter the target polluted region of the plurality of polluted regions. When the virtual object is located in the target polluted region, the target pollution source in the target polluted region generates impact on the virtual object. The terminal displays the region impact value of the position of the virtual object to indicate a magnitude of the impact of the target pollution source on the virtual object. The magnitude of the impact is equal the degree of the pollution caused by the target pollution source to the position of the virtual object. In other words, the region impact value of the position of the virtual object is configured for representing the degree of the pollution caused by the target pollution source to the position of the virtual object. For example, the degree of the pollution caused by the target pollution source to the position of the virtual object is quantified by the region impact value of the position of the virtual object. The target pollution source may be at any position in the target polluted region. During the movement of the virtual object in the target polluted region, the region impact value displayed in the terminal changes with a change of the distance between the virtual object and the target pollution source. In some embodiments, a smaller distance between the virtual object and the target pollution source leads to a higher degree of pollution caused by the target pollution source to the position of the virtual object, and thereby leads to a larger region impact value. A larger distance between the virtual object and the target pollution source leads to a lower degree of pollution caused by the target pollution source to the position of the virtual object, and thereby leads to a smaller region impact value.
203: The terminal displays a target object when the distance between the virtual object and the target pollution source is not greater than a distance threshold, the target object being obtained by converting the target pollution source.

In this embodiment of this application, during the movement of the virtual object in the target polluted region, the terminal can display not only the region impact value but also the target object. The target object is obtained by converting the target pollution source. An occasion for converting the target pollution source to the target object is not limited in this embodiment of this application. For example, as the virtual object gradually approaches the target pollution source, the distance between the virtual object and the target pollution source gradually decreases. When the distance between the virtual object and the target pollution source does not exceed the distance threshold, the target pollution source may be converted to the target object. Exemplarily, the target object is a non-player character (NPC) in the virtual scene. The virtual object that may be controlled by the terminal can interact with the target object in the target polluted region.
204: The terminal displays the target polluted region as a target purified region when the virtual object defeats the target object, the target purified region being configured to reduce a region impact value exerted by a current existing pollution source on the target purified region.

In this embodiment of this application, a polluted region and an object in the polluted region exist reliance on each other. When the target object in the target polluted region is defeated by the virtual object, the target object is removed. Correspondingly, the terminal no longer displays the target polluted region, but displays a source region where the target polluted region is located as the target purified region. In other words, the virtual object is no longer under impact of the target polluted region. When the position of the virtual object is in the target purified region, the degree of the pollution to the position of the virtual object decreases. In other words, the region impact value of the position of the virtual object decreases. In this embodiment of this application, the purified region is a three-dimensional space region. The purified region is a shape of a projection of the three-dimensional space region on the ground. Correspondingly, the purified region may be in a circular, square, polygonal, or irregular shape, which is not limited in this embodiment of this application.

Embodiments of this application provide an interaction solution for a virtual object. The plurality of polluted regions are arranged in the virtual scene, and the region impact value of the position of the virtual object is displayed based on the distance between the virtual object and the target pollution source. The region impact value can reflect the degree of pollution caused by the target pollution source to the position of the virtual object. Because the target pollution source causes different degrees of pollution to different positions, the virtual object can be guided to quickly find the target pollution source. As the distance between the virtual object and the target pollution source continuously decreases, the target pollution source is converted to the target object when the distance between the virtual object and the target pollution source is not greater than the distance threshold, so that the virtual object can interact with the target object. By defeating the target object, the target polluted region is displayed as the target purified region. Since the target purified region can reduce the region impact value exerted by the current existing pollution source on the target purified region, the degree of pollution to the position of the virtual object can be reduced. In this way, content of a virtual battle is enriched, manners of interaction between a virtual object and an object of the virtual battle are increased, and human-machine interaction efficiency.

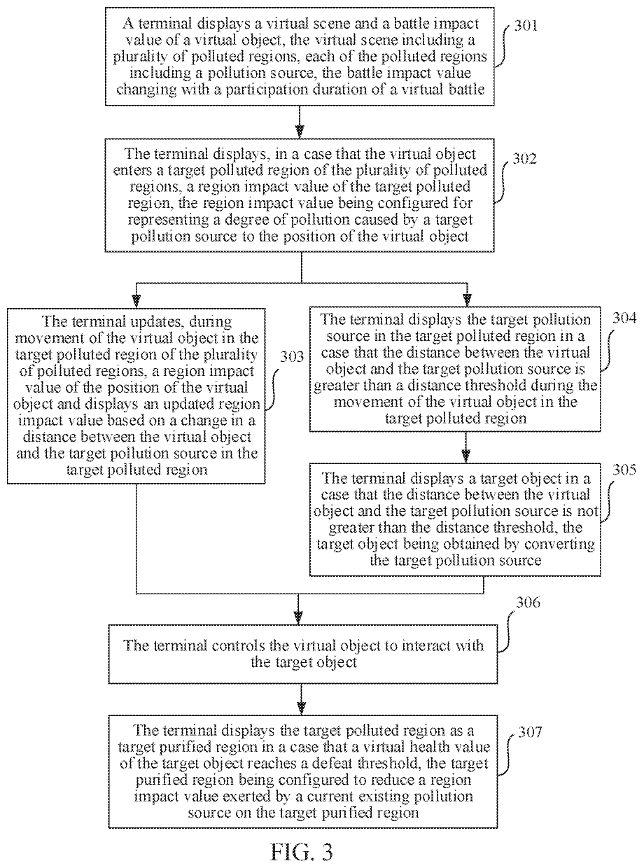

FIG. 3 is a flowchart of another interaction method for controlling a virtual object according to an embodiment of this application. Referring to FIG. 3, in this embodiment of this application, a description is provided by using an example in which a terminal performs the method. The interaction method for controlling a virtual object includes the following operations:
301: The terminal displays a virtual scene and a battle impact value of a virtual object, the virtual scene including a plurality of polluted regions, each of the polluted regions including a pollution source, the battle impact value changing with a participation duration of a virtual battle.

In this embodiment of this application, after the virtual battle starts, the terminal displays the virtual object in the virtual scene. The terminal further displays the battle impact value of a position of the virtual object while displaying the virtual scene. The battle impact value can indicate a degree of urgency of completing the virtual battle by the virtual object, and is configured for prompting the virtual object to complete a task objective of the virtual battle as soon as possible. The virtual object is constantly subject to the impact before the virtual battle ends. Battle impact values of positions in the virtual scene may be the same or different at any moment, which is not limited in this embodiment of this application. Regardless of a position of the virtual object in the virtual scene, the virtual object corresponds to a battle impact value. In some embodiments, the battle impact value decreases as the participation duration of the virtual battle increases, or increases as the participation duration of the virtual battle increases, which is not limited in this embodiment of this application.

For example, at any moment, the battle impact values of the positions in the virtual scene are the same, and the battle impact value increases as the participation duration of the virtual battle increases. When the virtual battle proceeds to a 15^{th} minute, the battle impact value of the position of the virtual object is 10. When the virtual battle proceeds to a 30^{th} minute, the battle impact value of the position of the virtual object is 20. The battle impact value can prompt a player that the current virtual battle has been in progress for a long time. If the virtual object cannot complete the task objective of the virtual battle as soon as possible, the battle may be considered as failed. In this embodiment of this application, the degree of urgency of completing the virtual battle by the virtual object is intuitively displayed through the battle impact value, so that the virtual object can actively find and complete the task objective of the virtual battle, thereby improving human-machine interaction efficiency. The participation duration of the virtual battle may also be referred to as a progress of the virtual battle.

In this embodiment of this application, the battle impact value is used to prompt the virtual object to complete the virtual battle as soon as possible. Moreover, the pollution source in the polluted region in the virtual scene generates impact on the virtual object that enters the polluted region, and a region impact value exerted by the pollution source on the virtual object can also prompt the virtual object to actively participate in the virtual battle, thereby eliminating the impact on the polluted region as soon as possible and completing the virtual battle. Reference is made to operation 302 described below. 5, 6, 7, or another quantity of polluted regions may exist in the virtual scene, which is not limited in this embodiment of this application.

Any one of the polluted regions includes a pollution source polluted region. An object is associated with the pollution source. The terminal can control the virtual object to enter the polluted region, and then control the virtual object to interact with the object associated with the pollution source.

In some embodiments, when the virtual battle starts, the terminal may select a specific quantity of reference regions from a plurality of reference regions arranged in advance as the polluted regions of the virtual battle. Correspondingly, the terminal arranges n reference regions in advance in the virtual scene. n is a positive integer. Then the terminal randomly selects m reference regions from the n reference regions as the polluted regions of the virtual battle in response to a start instruction of the virtual battle. In other words, during the virtual battle, the virtual scene includes m polluted regions. m is a positive integer. In some embodiments, m belongs to an interval [a, b], and a<b. Different virtual battles may correspond to different values. If n<a, n is less than m. In this case, the terminal directly uses the n reference regions as the polluted regions of the virtual battle.

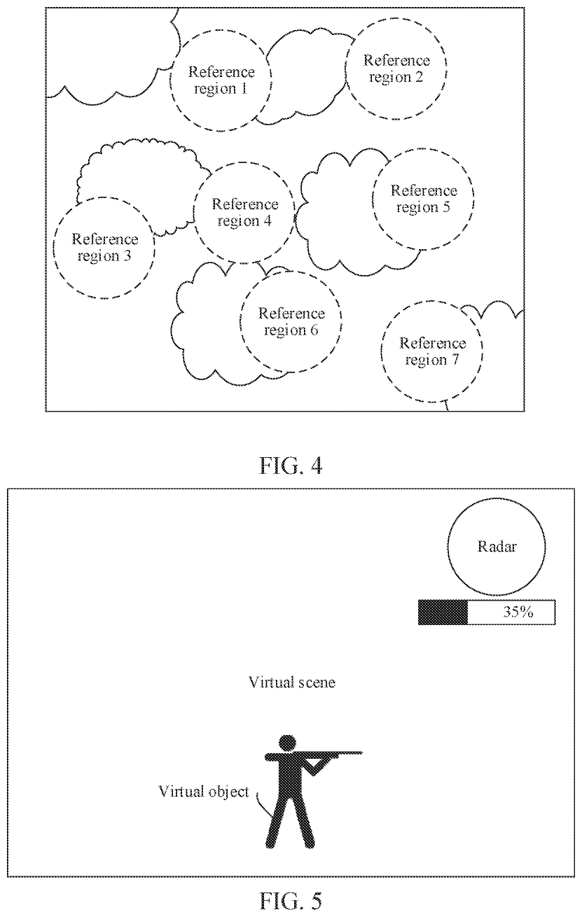

For example, FIG. 4 is a schematic diagram of a reference region according to an embodiment of this application. Referring to FIG. 4, 7 reference regions are arranged in the virtual scene. Irregular regions in FIG. 4 are configured for representing a terrain of a ground in the virtual scene. When the virtual battle starts, the terminal may randomly select a specific quantity of reference regions from the 7 reference regions as the polluted regions of the virtual battle. For example, when the virtual battle starts, the terminal randomly displays a reference region 1, a reference region 2, a reference region 3, a reference region 4, and a reference region 5 in the virtual scene as 5 polluted regions of the virtual battle.

In some embodiments, when n reference regions are arranged in advance, the terminal may determine a position of each reference region based on a position of a spawn point of the virtual object in the virtual scene, so that at least one spawn point exists near each reference region. For example, a distance between the position of the reference region and the position of the spawn point of the virtual object is not less than a first distance, to avoid degrading of experience of a player as a result of the virtual object finding the polluted region excessively quickly. Alternatively, the terminal may determine the position of the reference region based on a position of a target battle object of the virtual battle. For example, a distance between the position of the reference region and the position of the target battle object of the virtual battle is not less than a second distance, so as to avoid interference to interaction in the polluted region as a result of the target battle object being triggered when the virtual object interacts, in the region, with the object in the region. The target battle object is a final objective of the virtual battle. After the target battle object is defeated, the virtual battle ends.

In some embodiments, in addition to randomly selecting the polluted regions from the plurality of reference regions arranged in advance, the terminal may further select, for the virtual object in different manners, reference regions that meet a condition from the plurality of reference regions arranged in advance as the polluted regions of the virtual battle.

Manner I: Pollution sources in different polluted regions cause different degrees of pollution to the position of the virtual object. Correspondingly, attribute values such as an attack value and a health value of objects associated with the pollution sources in different polluted regions are different. The terminal can obtain an object level of the virtual object. Then the terminal determines objects with a level matching the object level. Next, the terminal uses reference regions where pollution sources associated with the objects are located as the polluted regions of the virtual battle. In the solution provided in this embodiment of this application, the regions where the pollution sources associated with the objects with the level matching the object level of the virtual object are located, so that the virtual object neither defeats the objects quickly nor fails to defeat the objects. In other words, the virtual battle neither ends quickly, nor fails to end after a long time or even fail, thereby improving the experience of the player.

Manner II: Most virtual objects can defeat only a limited quantity of objects, and cannot always defeat an object. The terminal can obtain a historical interaction record of the virtual object. The historical interaction record includes a plurality of objects defeated by the virtual object in a historical period of time. Then the terminal selects, based on the historical interaction record, reference regions where pollution sources associated with objects that can be defeated by the virtual object are located from the plurality of reference regions as the polluted regions of the virtual battle. In the solution provided in this embodiment of this application, the reference regions where the pollution sources associated with the objects that can be defeated by the virtual object are located are selected through the historical interaction record of the virtual object, so that the virtual object can complete the virtual battle, thereby improving the experience of the player.

A server may also arrange a plurality of reference regions in advance, and select a specific quantity of reference regions from the plurality of reference regions as the polluted regions of the virtual battle. This manner is similar to the foregoing manner of determining the polluted regions by the terminal, and therefore is not described in detail herein.

In some embodiments, the battle impact value can not only indicate a degree of pollution caused by global pollution of the entire virtual battle to the position of the virtual object, but also indicate the degree of urgency of completing the virtual battle by the virtual object. The terminal can display the virtual scene based on the degree of the impact on the position of the virtual object. In other words, the terminal can render the virtual scene based on the battle impact value of the position of the virtual object. Correspondingly, the terminal obtains the battle impact value of the position of the virtual object. Then the terminal determines a first rendering parameter of the virtual scene based on the battle impact value. Next, the terminal displays the virtual scene based on the first rendering parameter. The first rendering parameter includes a parameter for indicating a brightness of the virtual scene. A larger battle impact value of the position of the virtual object leads to a lower brightness of the virtual scene displayed on the terminal, and thereby leads to a darker virtual scene. A smaller battle impact value of the position of the virtual object leads to a higher brightness of the virtual scene displayed on the terminal, and thereby leads to a brighter virtual scene. In the solution provided in this embodiment of this application, the virtual scene is rendered based on the battle impact value of the position of the virtual object. Since rendering parameters determined based on different battle impact values are different, the brightnesses of the rendered virtual scene are also different, which enriches display forms of the virtual scene, realizes immersive experience for the player, and improves battle experience.
302: The terminal displays, when the virtual object enters a target polluted region of the plurality of polluted regions, a region impact value of the target polluted region, the region impact value being configured for representing a degree of pollution caused by a target pollution source to the position of the virtual object.

In this embodiment of this application, the target polluted region is any one of the plurality of polluted regions. When the terminal controls the virtual object to explore the virtual scene, the virtual object can be controlled to enter the target polluted region. When the virtual object enters the target polluted region, the position of the virtual object is already in a range that can be polluted by the target pollution source in the target polluted region. A magnitude of the degree of the pollution is indicated by the region impact value of the target polluted region. In some embodiments, during movement of the virtual object in different polluted regions, a change amplitude of the region impact value of the virtual object may or may not vary, which is not limited in this embodiment of this application.

In some embodiments, the terminal can display the region impact value of the target polluted region on the virtual scene in different manners. Reference is made to the following two display manners.

Manner I: The terminal displays the battle impact value and the region impact value on the virtual scene independently. By displaying the battle impact value and the region impact value independently, the magnitude of the pollution caused by the virtual battle to the position of the virtual object and the magnitude of the pollution caused by the target polluted region to the position of the virtual object can be intuitively displayed. Therefore, a decision of the player can be intervened with based on the magnitude of the pollution, and maintaining/removal of the virtual object can be controlled based on an operation corresponding to the decision of the player, thereby improving the human-machine interaction efficiency.

Manner II: The terminal can display a sum of the battle impact value and the region impact value on the virtual scene. Correspondingly, the terminal performs summation on the battle impact value and the region impact value to obtain an impact sum. Then the terminal displays the impact sum on the virtual scene. In some embodiments, the terminal can directly display the impact sum without performing the operation of displaying the region impact value, to avoid impact on determination of the player as a result of the player perceiving a sudden value change. The terminal may alternatively cancel displaying of the battle impact value and the region impact value, and display only the impact sum, to replace the battle impact value and the region impact value with the impact sum. The terminal may alternatively display all of the battle impact value, the region impact value, and the impact sum. The manner of displaying the impact sum is not limited in this embodiment of this application. By displaying the sum of the battle impact value and the region impact value, all pollution to the virtual object in the virtual scene can be intuitively displayed, which not only enriches content of the virtual battle, but also realizes control of maintaining/removal of the virtual object based on the magnitude of the pollution, thereby improving the human-machine interaction efficiency.

In some embodiments, the battle impact value affects the displaying of the virtual scene, and the battle impact value and the region impact value also affect the displaying of the virtual scene after being superimposed. Correspondingly, when the virtual object is located outside the plurality of polluted regions, the magnitude of the pollution to the position of the virtual object is indicated by the battle impact value. In this case, the terminal can render the virtual scene based on the battle impact value, namely, in the manner in operation 301. Details are not described herein. When the terminal controls the virtual object to enter the target polluted region, the magnitude of the pollution to the portion of the virtual object is indicated by the sum of the battle impact value and the region impact value of the target polluted region. In this case, the terminal can render the virtual scene based on the battle impact value and the region impact value. Correspondingly, the terminal obtains the battle impact value and at least one region impact value of the position of the virtual object. Then the terminal determines a second rendering parameter of the virtual scene based on a sum of the battle impact value and the at least one region impact value. Next, the terminal displays the virtual scene based on the second rendering parameter. The second rendering parameter includes a parameter for indicating a brightness of the virtual scene. A larger sum of the battle impact value and the region impact value leads to a lower brightness of the virtual scene displayed on the terminal, and thereby leads to a darker virtual scene. A smaller sum of the battle impact value and the region impact value leads to a higher brightness of the virtual scene displayed on the terminal, and thereby leads to a brighter virtual scene. In the solution provided in this embodiment of this application, the virtual scene is rendered based on the battle impact value and the region impact value of the position of the virtual object. Since rendering parameters determined based on different battle impact values and region impact values are different, the brightnesses of the rendered virtual scene are also different, which enriches display forms of the virtual scene, realizes immersive experience for the player, and improves battle experience.

In some embodiments, the terminal may alternatively render the virtual scene based on the region impact value of the position of the virtual object. This manner is similar to the foregoing manner of rendering the virtual scene based on the battle impact value, and therefore is not described in detail herein. In the solution provided in this embodiment of this application, the virtual scene is rendered based on the region impact value of the position of the virtual object. Since rendering parameters determined based on different region impact values are different, the brightnesses of the rendered virtual scene are also different, which enriches display forms of the virtual scene, realizes immersive experience for the player, and improves battle experience.

In some embodiments, a plurality of virtual objects may team up to participate in the virtual battle. During the virtual battle, impact is generated to all of the plurality of virtual objects. For any one of the virtual objects, an impact value of a position of the virtual object may be a battle impact value, or may be a sum of the battle impact value and a region impact value. The plurality of impact values of the positions of the plurality of virtual objects may be the same or different. The terminal can render the virtual scene based on a sum of the plurality of impact values of the positions of the plurality of virtual objects. Correspondingly, the terminal obtains the plurality of impact values of the positions of the plurality of virtual objects. Then the terminal determines a third rendering parameter of the virtual scene based on the sum of the plurality of impact values. Next, the terminal displays the virtual scene based on the third rendering parameter. In the solution provided in this embodiment of this application, the virtual scene is rendered based on the plurality of impact values of the positions of the plurality of virtual objects. Since rendering parameters determined based on different impact values are different, the brightnesses of the rendered virtual scene are also different, which enriches display forms of the virtual scene, realizes immersive experience for the player, and improves battle experience.
303: The terminal updates, during movement of the virtual object in the target polluted region of the plurality of polluted regions, a region impact value of the position of the virtual object and displays an updated region impact value based on a change in a distance between the virtual object and the target pollution source in the target polluted region.

In this embodiment of this application, since the target pollution source in the target polluted region does not move, as the virtual object moves in the target polluted region, the distance between the virtual object and the target pollution source changes, and the region impact value displayed on the terminal also changes. A smaller distance between the virtual object and the target pollution source leads to a larger region impact value. A larger distance between the virtual object and the target pollution source leads to a smaller region impact value.

In some embodiments, a function relationship exists between the distance between the virtual object and the target pollution source and the region impact value of the position of the virtual object. The terminal can display the region impact value of the position of the virtual object based on the function relationship and the distance between the virtual object and the target pollution source. Correspondingly, the terminal obtains an impact value curve of the target polluted region. Then the terminal determines the region impact value of the position of the virtual object based on the impact value curve and the distance between the virtual object and the target pollution source in the target polluted region. Next, the terminal displays the region impact value on the virtual scene. The impact value curve is configured for indicating region impact values corresponding to different distances. In other words, the impact value curve is configured for indicating a relationship between a region impact value and a distance. For example, the impact value curve can represent the function relationship between the distance between the virtual object and the target pollution source and the region impact value of the position of the virtual object. Impact value curves of different polluted regions may be the same or different, which is not limited in this embodiment of this application. In the solution provided in this embodiment of this application, the region impact value of the position of the virtual object is determined based on the impact value curve of the target polluted region and the distance between the virtual object and the target pollution source, so that a more accurate region impact value can be determined. In addition, by displaying the region impact value, the pollution to the position of the virtual object can be intuitively displayed, which enriches the content of the virtual battle.

In some embodiments, the target polluted region may have an overlapping part with at least one non-target polluted region of the plurality of polluted regions. During the movement of the virtual object in the target polluted region of the plurality of polluted regions, the virtual object may move into the overlapping part. In this case, the position of the virtual object is not only polluted by the target polluted region, but also by the at least one non-target polluted region. Therefore, the region impact value of the position of the virtual object displayed on the terminal changes. Correspondingly, during the movement of the virtual object in the target polluted region of the plurality of polluted regions, when the virtual object enters the overlapping part, the terminal determines a first region impact value and at least one second region impact value. Then the terminal displays a sum of the first region impact value and the at least one second region impact value as the region impact value of the position of the virtual object. The first region impact value is determined based on the target polluted region. The at least one second region impact value is determined based on the at least one non-target polluted region. The at least one non-target polluted region has an overlapping part with the target polluted region. The position of the virtual object is in the overlapping part. In other words, the virtual object is located in both the target polluted region and the at least one non-target polluted region. In the solution provided in this embodiment of this application, the region impact value of the position of the virtual object is displayed as the sum of the region impact values of the plurality of polluted regions where the virtual object is located, so that overall pollution to the position of the virtual object can be intuitively displayed, and the content of the virtual battle is enriched.

In some embodiments, the region impact value may be displayed on an upper part, a left side, or a right side of a screen of the terminal, which is not limited in this embodiment of this application. The region impact value may be displayed as a numerical value or as a percentage, which is not limited in this embodiment of this application.

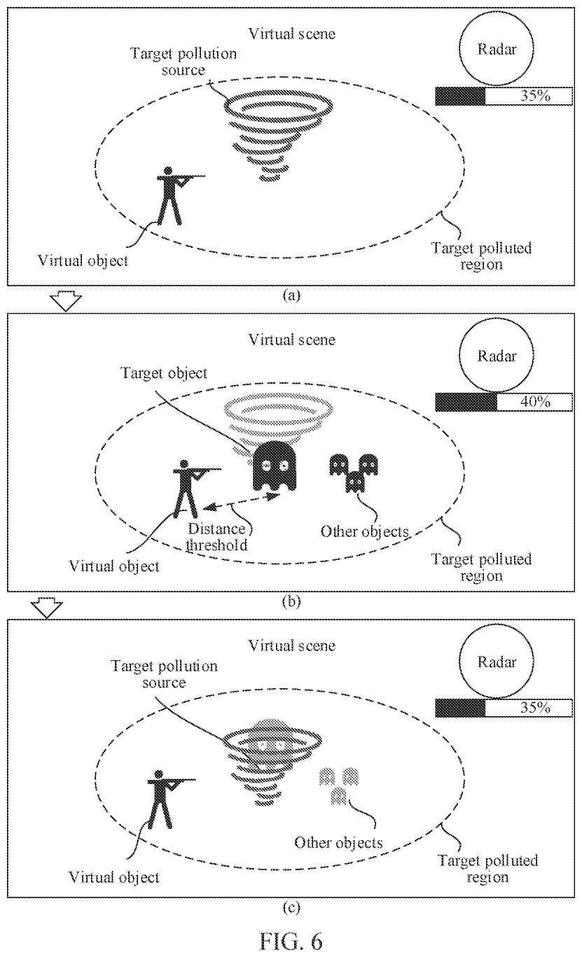

For example, FIG. 5 is a schematic diagram of a region impact value according to an embodiment of this application. Referring to FIG. 5, the terminal displays a virtual scene of a virtual battle. A virtual object is displayed in the virtual scene. In an upper right corner of the screen of the terminal, the terminal displays a radar control. The radar control is configured to indicate a current position of the virtual object. The terminal displays a region impact value as a percentage below the radar control. The region impact value is 35%.

In some embodiments, the pollution source has a plurality of forms. As the distance between the virtual object and the target pollution source changes, the form of the target pollution source also changes. For details, reference is made to operation 304 to operation 305.
304: The terminal displays the target pollution source in the target polluted region when the distance between the virtual object and the target pollution source is greater than a distance threshold during the movement of the virtual object in the target polluted region.

A magnitude of the distance threshold is not limited in this embodiment of this application, the embodiment of this application, which may be set based on experience or flexibly adjusted based on a scene. For example, the distance threshold may be 10 meters, 15 meters, or 20 meters, which is not limited in this embodiment of this application. Distance thresholds corresponding to pollution sources in different polluted regions may be the same or different, which is not limited in this embodiment of this application. When the distance between the virtual object and the target pollution source is greater than the distance threshold, the target pollution source is in a nonactivated state. In this case, the target pollution source neither moves nor interacts with the virtual object. In other words, the target pollution source cannot be attacked by the virtual object, and cannot attack the virtual object.

In some embodiments, the terminal can display the target pollution source through a special effect. The special effect may be tornado, typhoon, or fog, which is not limited in this embodiment of this application. It may be learned that, when the distance between the virtual object and the target pollution source is greater than the distance threshold, the target pollution source is a non-entity.

For example, FIG. 6 is a schematic diagram of conversion between a target pollution source and a target object according to an embodiment of this application. Referring to FIG. 6, (a) in FIG. 6 exemplarily shows that the terminal uses the tornado effect to present the target pollution source existing when the distance between the virtual object and the target pollution source is greater than the distance threshold.
305: The terminal displays a target object when the distance between the virtual object and the target pollution source is not greater than the distance threshold, the target object being obtained by converting the target pollution source.

In this embodiment of this application, as the virtual object gradually approaches the target pollution source, the distance between the virtual object and the target pollution source gradually decreases. When the distance between the virtual object and the target pollution source is not greater than the distance threshold, the terminal displays the target object. An occasion for converting the target pollution source to the target object is not limited in this embodiment of this application. For example, when the distance between the virtual object and the target pollution source is equal to the distance threshold, the terminal converts the target pollution source to the target object. The target object may be considered as a form of the target pollution source. The target pollution source displayed in the form of the target object is in an activated state. In this case, the target object can move or interact with the virtual object. In other words, the target object can be attacked by the virtual object, and can attack the virtual object. The target object may be displayed in a humanoid form, a mechanical form, or other forms. In this case, the target object is an entity. In some embodiments, when the target pollution source is converted to the target object, the terminal not only displays the target object, but also displays other objects near the target object. The other objects can also interact with the virtual object.

For example, still referring to FIG. 6, (b) in FIG. 6 is an exemplary schematic diagram of converting a target pollution source to a target object. The target pollution source is converted to the humanoid form from the tornado form. A plurality of other objects are further displayed around the target object. During the conversation of the form, the special tornado effect gradually becomes transparent, and the target object gradually becomes clear. The terminal may set a function curve to control the conversion of the target pollution source to the target object. In some embodiments, an association exists between the target pollution source and the target object. For example, some special effects in the target pollution source may remain on the target object to prompt the target object.

Operation 304 and operation 305 described above are optional operations. When the target pollution source is displayed in the target polluted region in a non-interactive form, the terminal can convert the target pollution source to the target object through operation 304 and operation 305 described above. Then the terminal further performs operation 306 to control the virtual object to interact with the target object. During the movement of the virtual object in the target polluted region, the form of the target pollution source changes. The target pollution source is converted to the target object. In other words, an occasion for performing operation 304 and operation 305 may be the same as an occasion for performing operation 303. The terminal can perform operation 304 and operation 305 during the control of the movement of the virtual object in the target polluted region in operation 303. When the target pollution source is displayed in the target polluted region in the form of the target object, the terminal does not need to perform operation 304 and operation 305, and directly performs operation 306 after operation 303, so that the virtual object interacts with the target object.
306: The terminal controls the virtual object to interact with the target object.

In this embodiment of this application, the interaction between the virtual object and the target object includes various interactive behaviors such as attack, defense, and pursuit. Attack, defense, and pursuit are interactive behaviors among objects in a game.

In some embodiments, when the terminal controls the virtual object to move away from the target object, the target object can pursue the virtual object. Correspondingly, the terminal controls the virtual object to move away from the target object. When the distance between the virtual object and the target object is less than the distance threshold, the terminal displays the target object pursuing the virtual object. In the solution provided in this embodiment of this application, when the distance between the virtual object and the target object is less than the distance threshold, the target virtual object can pursue the virtual object, which increases manners of interaction between the virtual object and the object in the polluted region.

In some embodiments, as the virtual object gradually moves away from the target object, the distance between the virtual object and the target object gradually increases. When the target object cannot pursue the virtual object, the target object gives up the pursuit. Correspondingly, the terminal controls the virtual object to move away from the target object. When the distance between the virtual object and the target object is greater than or equal to the distance threshold, the terminal displays the target object being converted to the target pollution source. In this case, the target pollution source can neither move nor interact with the virtual object. In some embodiments, after giving up the pursuit, the target object may be directly converted to the target pollution source at a current position, or may return to an initial position of the target object and then be converted to the target pollution source. The initial position is a position where the target pollution source is converted to the target object. In the solution provided in this embodiment of this application, when the distance between the virtual object and the target object is greater than or equal to the distance threshold, the target object is converted to the target pollution source, which not only enriches display manners of the target pollution source, but also enriches the content of the virtual battle.

For example, still referring to FIG. 6, (c) in FIG. 6 is an exemplary schematic diagram of converting a target object to a target pollution source. As shown in the figure, the target object is converted to the tornado form from humanoid form. During the conversion of the form, the target object and other objects around the target object gradually become transparent. The special tornado effect gradually become clear. The terminal may set a function curve to control the conversion of the target object to the target pollution source.

In some embodiments, as the target object moves, the position of the target polluted region also changes, so that the target object is always in the target polluted region. In some embodiments, the position of the target object relative to the target polluted region may be maintained or changed.

When the virtual object approaches the target pollution source again, the terminal repeats operation 304 to operation 306 described above. Correspondingly, when the distance between the virtual object and the target pollution source is greater than the distance threshold, the terminal displays the target pollution source in the target polluted region again. In this case, the target pollution source can neither move nor interact with the virtual object. When the distance between the virtual object and the target object is equal to the distance threshold, the terminal displays the target pollution source being converted to the target object again. When the distance between the virtual object and the target object is greater than or equal to the distance threshold, the terminal displays the target object being converted to the target pollution source again.

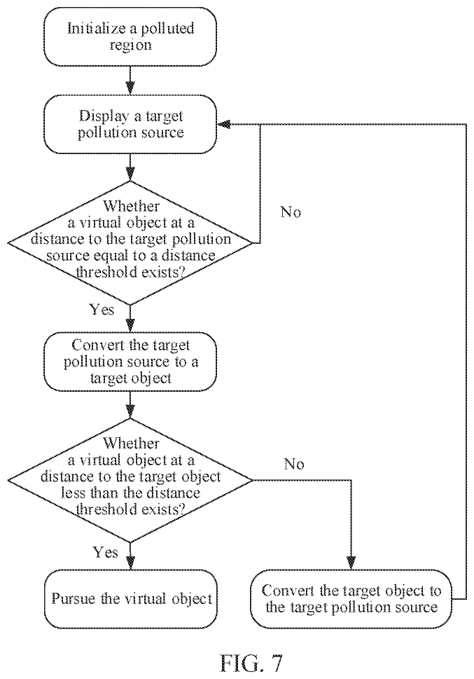

To more clearly describe the conversion process between the target pollution source and the target object, the conversion process is further described again with reference to the drawings. FIG. 7 is a flowchart of conversion between a target pollution source and a target object according to an embodiment of this application. Referring to FIG. 7, when the virtual battle starts, the terminal initializes the plurality of polluted regions in the virtual scene of the virtual battle. The target polluted region of the plurality of polluted regions is used as an example. The terminal displays the target pollution source in the target polluted region. The terminal detects whether a virtual object at a distance to the target pollution source equal to the distance threshold exists. If the virtual object at the distance to the target pollution source equal to the distance threshold does not exist, the terminal still displays the target pollution source. If the virtual object at the distance to the target pollution source equal to the distance threshold exists, the terminal converts the target pollution source to the target object. Then the terminal detects whether a virtual object at a distance to the target object less than the distance threshold exists. If the virtual object at the distance to the target object less than the distance threshold exists, the terminal displays the virtual object interacting with the target object. The target object can pursue the virtual object. If the virtual object at the distance to the target object less than the distance threshold does not exist, the terminal converts the target object to the target pollution source. Then the terminal still displays the target pollution source until a virtual object reappears at the position at the distance to the target pollution source equal to the distance threshold.

In some embodiments, an association relationship exists between a pollution degree of a pollution source and an attribute value of an object to which the pollution source may be converted. A higher pollution degree of the pollution source leads to a higher attribute value of the object to which the pollution source may be converted. A lower pollution degree of the pollution source leads to a lower attribute value of the object to which the pollution source may be converted. The attribute value is at least one of a plurality of values such as an attack value, a health value, and a defense value, which is not limited in this embodiment of this application. During interaction between the virtual object and the object to which the pollution source may be converted, objects having different attribute values generate different impact on the virtual object. For example, an object having a higher attribute value launches a stronger attack on the virtual object, resulting in larger damage to the virtual object and higher difficulty for the virtual object to defeat the object. An object having a lower attribute value launches a weaker attack on the virtual object, resulting in smaller damage to the virtual object and lower difficulty for the virtual object to defeat the object. Pollution degrees of pollution sources in different polluted regions are different, and region impact values displayed on the terminal are also different. By displaying the region impact value of the target polluted region on the terminal, the pollution degree of the target pollution source in the target polluted region can be intuitively displayed, which provides a reference for the player to learn the attribute of the target object, and intervenes with the decision of the player, thereby improving the human-machine interaction efficiency.

In some embodiments, the pollution source can further reduce the attribute value of the virtual object. Pollution sources with different pollution degrees generate different degrees of impact on the virtual object. A higher pollution degree of a pollution source leads to a larger decrease in an attribute value of a virtual object in a polluted region where the pollution source is located. A lower pollution degree of the pollution source leads to a smaller decrease in the attribute value of the virtual object in the polluted region where the pollution source is located. Alternatively, a higher pollution degree of the pollution source leads to a quicker decrease in the attribute value of the virtual object in the polluted region where the pollution source is located. A lower pollution degree of the pollution source leads to a slower decrease in the attribute value of the virtual object in the polluted region where the pollution source is located. The above is not limited in this embodiment of this application. By displaying the region impact value of the target polluted region on the terminal, the pollution degree of the target pollution source in the target polluted region can be intuitively displayed, which provides a reference for the player to learn a current situation of the virtual object, and intervenes with the decision of the player, thereby improving the human-machine interaction efficiency.

In some embodiments, as the virtual battle proceeds, the polluted region in the virtual scene evolves. The evolution refers to an increase in the degree of the pollution caused by the polluted region to the position of the virtual object. In other words, the region impact value exerted by the pollution source in the polluted region on the position of the virtual object increases. The terminal can display prompt information indicating the evolution of the polluted region. Correspondingly, the terminal displays first prompt information in response to a region evolution instruction. The first prompt information is configured for prompting that a region impact value of a polluted region increases with a change amplitude of a distance from a pollution source in the region and that an attribute value of an object corresponding to the pollution source in the polluted region increases. The polluted region refers to a polluted region having a non-interactive pollution source. The region evolution instruction does not generate impact on a polluted region in which an object corresponding to a pollution source is displayed.

For example, FIG. 8 is a schematic diagram of first prompt information according to an embodiment of this application. Referring to FIG. 8, when the polluted region in the virtual battle has evolved, the terminal displays prompt information on an upper part of the virtual scene. As shown in FIG. 8, the prompt information is “Attention! Polluted regions of the entire battle have evolved”.

In some embodiments, as the virtual battle proceeds, the virtual battle also evolves. In other words, the battle impact value of the position of the virtual object changes. The terminal can display prompt information indicating the evolution of the battle. Correspondingly, the terminal displays second prompt information in response to a battle evolution instruction. The second prompt information is configured for indicating that the battle impact value increases.
307: The terminal displays the target polluted region as a target purified region when a virtual health value of the target object reaches a defeat threshold, the target purified region being configured to reduce a region impact value exerted by a current existing pollution source on the target purified region.

In this embodiment of this application, when the terminal controls the virtual object to interact with the target object, the terminal may reduce the virtual health value of the target object. Defeat thresholds of different objects may be the same or different, which is not limited in this embodiment of this application. In addition, the defeat threshold may be set based on experience or flexibly adjusted based on an application scenario. When the virtual health value of the target object is less than the defeat threshold of the target object, the target object is defeated by the virtual object. Then the terminal removes the target object from the virtual scene. Because the target object and the target polluted region exist with reliance on each other, when the target object is removed, the terminal no longer displays the target polluted region. Therefore, the position of the virtual object is no longer polluted by the target pollution source in the target polluted region.

In some embodiments, when the target object is removed, the terminal can display a special removal effect to intuitively show that the target object has been removed from the virtual scene. The target polluted region also disappears. The special removal effect may be an explosion or a crush, which is not limited in this embodiment of this application.

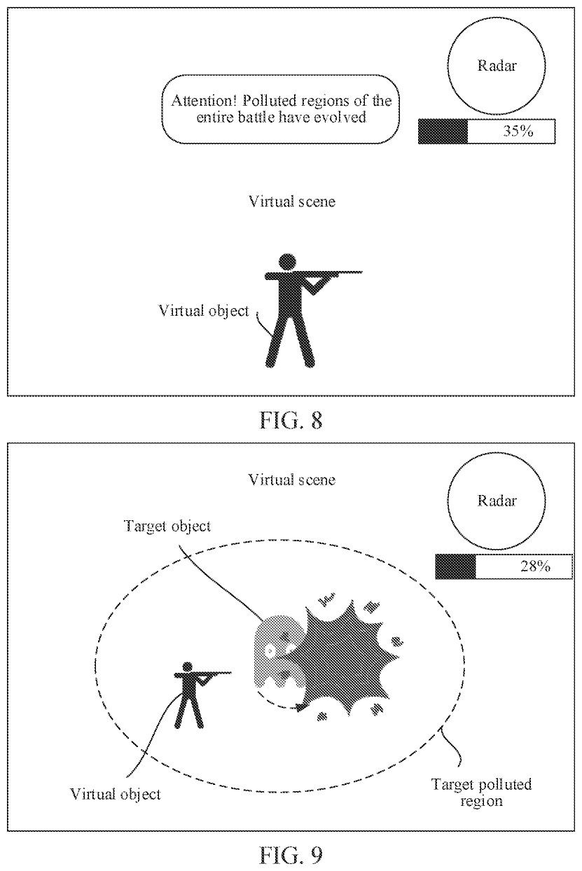

For example, FIG. 9 is a schematic diagram of removing a target object according to an embodiment of this application. Referring to FIG. 9, when the virtual health value of the target object is less than the defeat threshold, the terminal displays a special explosion effect at the position of the target object, to replace the target object previously displayed. Through the special explosion effect, the terminal indicates that the virtual scene no longer includes the target object and the target polluted region.

In this embodiment of this application, after the virtual object defeats the target object, the terminal can display the target purified region based on a position where the target object is defeated. The virtual object can obtain an award for defeating the target object in the target purified region. The award includes increasing at least one attribute value of the virtual object and reducing the region impact value of the position of the virtual object. The attribute value may be an attack value, a health value, a defense value, or the like, which is not limited in this embodiment of this application. The terminal can display the at least one increased attribute value and the reduced region impact value. The terminal can also display a special purified region effect in the target purified region. The special purified region effect may be diffusing ripples, a halo, or haze, which is not limited in this embodiment of this application.

In some embodiments, a purified region exists in the virtual scene. The terminal can determine whether to display the target purified region based on a position relationship between the target object and the existing purified region. Correspondingly, the terminal displays the special purified region effect in the purified region when the position of the target object is in the purified region. When the position of the target object is not in any purified region, the terminal displays the target purified region. The special purified region effect is displayed in the target purified region. In the solution provided in this embodiment of this application, when the target object is located in the existing purified region, the terminal displays the special purified region effect in only the existing purified region, and no longer displays the target purified region to reduce consumption for operation. When the target object is not located in any existing purified region, the terminal displays the target purified region and the special purified region effect, which enriches the content of the virtual battle.

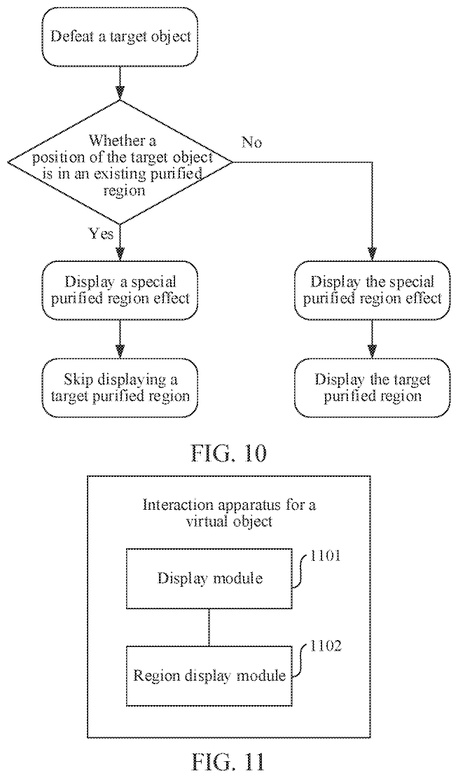

For example, FIG. 10 is a flowchart of displaying a target purified region according to an embodiment of this application. Referring to FIG. 10, when the target object is defeated, the terminal detects whether the position of the target object is in the existing purified region. If the position of the target object is in the existing purified region, the terminal displays the special purified region effect in the purified region where the target object is located, and does not display the target purified region. If the position of the target object is not in the existing purified region, the terminal displays the target purified region, and displays the special purified region effect in the target purified region.

In some embodiments, the position of the target polluted region changes with the movement of the target object. Therefore, to avoid a conflict between the polluted region and the purified region, when the target polluted region covers a center of any purified region, the displaying of the purified region is canceled. In other words, when the polluted region covers the center of the existing purified region during the movement of the polluted region, the terminal no longer displays the purified region whose center is covered.

In some embodiments, a plurality of purified regions are displayed in the virtual scene. The plurality of purified regions may or may not have overlapping parts. Positions of the plurality of purified regions in the virtual scene are not limited in this embodiment of this application. When the terminal controls the virtual object to enter the overlapping part of the purified regions, the terminal can adjust the region impact value of the position of the virtual object based on each purified region where the virtual object is located. Correspondingly, the terminal adjusts the region impact value of the position of the virtual object based on at least two purified regions when the virtual object enters an overlapping part of the at least two purified regions. Then the terminal can display the adjusted region impact value. In the solution provided in this embodiment of this application, the region impact value of the virtual object is adjusted through each purified region where the virtual object is located. By displaying the adjusted region impact value, an award provided by the purified region for the virtual object can be intuitively displayed, which enriches the content of the virtual battle.

In some embodiments, the terminal can obtain at least two award values assigned by the at least two purified regions to the virtual object. The award values are configured for reducing the region impact value of the position of the virtual object. Then the terminal adjusts the region impact value of the virtual object based on a larger one of the at least two award values.

In some embodiments, the purified region has a limited existence time. Each purified region corresponds to a duration threshold. The terminal controls a display duration of the purified region through the duration threshold. Correspondingly, when the display duration of the target purified region is equal to a target duration threshold, the displaying of the target purified region is canceled. The target duration threshold is a maximum display duration of the target purified region. The duration threshold corresponding to each purified region may be set based on experience or adjusted based on a scene. The duration threshold corresponding to the purified region is not limited in this embodiment of this application.

The terminal can repeat operation 302 to operation 307 described above, to remove the plurality of polluted regions in the virtual scene. The terminal can further remove some rather than all polluted regions in the virtual scene.

In some embodiments, the virtual scene further includes a target battle object. The target battle object is a task objective of the virtual battle. The terminal can control the virtual object to find and defeat the target battle object to complete the virtual battle. Correspondingly, when the virtual object defeats the target battle object, the terminal removes all remaining objects from the virtual scene. Then the terminal displays a special battle ending effect centered around the position of the target battle object. Next, the terminal ends the virtual battle. When the virtual object defeats the target battle object, the terminal no longer displays all remaining polluted regions in the virtual battle. The special battle ending effect may be diffusing ripples, a scene explosion, or the like, which is not limited in this embodiment of this application. The terminal can further render the virtual scene at a target brightness based on a rendering parameter at the end of the battle. The target brightness is greater than a brightness configured for rendering the virtual scene in presence of the polluted regions.

This embodiment of this application provides an interaction method for controlling a virtual object. The plurality of polluted regions are displayed in the virtual scene, and the region impact value of the position of the virtual object is displayed based on the distance between the virtual object and the target pollution source. The region impact value can reflect the degree of pollution caused by the target pollution source to the position of the virtual object. Because the target pollution source causes different degrees of pollution to different positions, the virtual object can be guided to quickly find the target pollution source without aimless searching. As the distance between the virtual object and the target pollution source continuously decreases, when the distance between the virtual object and the target pollution source is equal to the distance threshold, the target object obtained by converting the target pollution source is displayed, which enriches the display manners of the object. By converting the target pollution source into the target object, the virtual object can interact with the target object. When the target object is defeated, the target purified region is displayed, to realize an award to the virtual object and reduce the region impact value of the position of the virtual object. In this way, the content of the virtual battle is enriched, the manners of interaction between the virtual object and the object in the virtual battle are increased, and the human-machine interaction efficiency is improved.

FIG. 11 is a schematic structural diagram of an interaction apparatus for a virtual object according to an embodiment of this application. The apparatus is configured to perform the operations during execution of the foregoing interaction method for controlling a virtual object. Referring to FIG. 11, the apparatus includes a display module 1101 and a region display module 1102.

The display module 1101 is configured to display a virtual scene, the virtual scene including a plurality of polluted regions, each of the polluted regions including a pollution source.

The display module 1101 is further configured to display, during movement of the virtual object in a target polluted region of the plurality of polluted regions, a region impact value of a position of the virtual object based on a distance between the virtual object and a target pollution source in the target polluted region, the region impact value being configured for representing a degree of pollution caused by the target pollution source to the position of the virtual object.

The display module 1101 is further configured to display a target object when the distance between the virtual object and the target pollution source is not greater than a distance threshold, the target object being obtained by converting the target pollution source.

The region display module 1102 is configured to display the target polluted region as a target purified region when the virtual object defeats the target object, the target purified region being configured to reduce a region impact value exerted by a current existing pollution source on the target purified region.

This embodiment of this application provides an interaction solution for a virtual object. The plurality of polluted regions are arranged in the virtual scene, and the region impact value of the position of the virtual object is displayed based on the distance between the virtual object and the target pollution source. The region impact value can reflect the degree of pollution caused by the target pollution source to the position of the virtual object. Because the target pollution source causes different degrees of pollution to different positions, the virtual object can be guided to quickly find the target pollution source. As the distance between the virtual object and the target pollution source continuously decreases, the target pollution source is converted to the target object when the distance between the virtual object and the target pollution source is not greater than the distance threshold, so that the virtual object can interact with the target object. By defeating the target object, the target polluted region is displayed as the target purified region. Since the target purified region can reduce the region impact value exerted by the current existing pollution source on the target purified region, the degree of pollution to the position of the virtual object can be reduced. In this way, content of a virtual battle is enriched, manners of interaction between a virtual object and an object of the virtual battle are increased, and human-machine interaction efficiency.

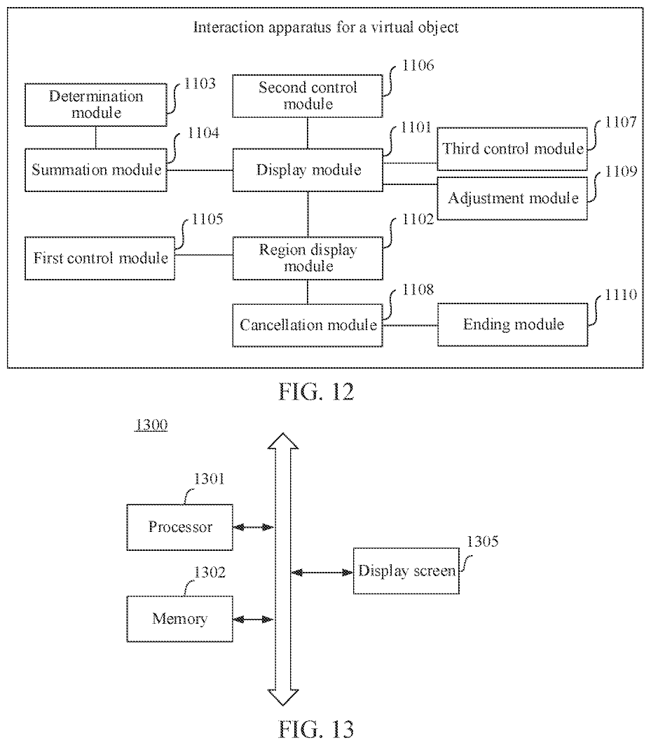

In some embodiments, FIG. 12 is a schematic structural diagram of another interaction apparatus for a virtual object according to an embodiment of this application. Referring to FIG. 12, the display module 1101 is configured to: obtain an impact value curve of the target polluted region, the impact value curve being configured for indicating region impact values corresponding to different distances; determine the region impact value of the position of the virtual object based on the impact value curve and the distance between the virtual object and the target pollution source in the target polluted region; and display the region impact value on the virtual scene.

In some embodiments, still referring to FIG. 12, the target polluted region has an overlapping part with a non-target polluted region of plurality of polluted regions.

The apparatus further includes:
a determination module 1103, configured to determine a first region impact value and at least one second region impact value when the virtual object enters the overlapping part during movement of the virtual object in the target polluted region of the plurality of polluted regions, the first region impact value being determined based on the target polluted region, and the at least one second region impact value being determined based on at least one non-target polluted region.

The display module 1101 is further configured to display a sum of the first region impact value and the at least one second region impact value as the region impact value of the position of the virtual object.

In some embodiments, still referring to FIG. 12, a battle impact value of the position of the virtual object is displayed on the virtual scene, the battle impact value changing with a participation duration of a virtual battle.

The apparatus further includes:
a summation module 1104, configured to perform summation on the battle impact value and the region impact value to obtain an impact sum.

The display module 1101 is further configured to display the impact sum on the virtual scene.

In some embodiments, still referring to FIG. 12, the display module 1101 is configured to: obtain the battle impact value of the position of the virtual object, the battle impact value changing with the progress of the virtual battle; determine a first rendering parameter of the virtual scene based on the battle impact value; and display the virtual scene based on the first rendering parameter.

In some embodiments, still referring to FIG. 12, the display module 1101 is configured to: obtain the battle impact value and at least one region impact value of the position of the virtual object, the battle impact value changing with a progress of the virtual battle; determine a second rendering parameter of the virtual scene based on a sum of the battle impact value and the at least one region impact value; and display the virtual scene based on the second rendering parameter.

In some embodiments, still referring to FIG. 12,
the display module 1101 is further configured to display the target object obtained by converting the target pollution source when the distance between the virtual object and the target pollution source is equal to the distance threshold during the movement of the virtual object in the target polluted region.

In some embodiments, still referring to FIG. 12, the apparatus further includes:
a first control module 1105, configured to control the virtual object to interact with the target object.

The region display module 1102 is further configured to remove the target object from the virtual scene when a virtual health value of the target object reaches a defeat threshold.

In some embodiments, still referring to FIG. 12, the apparatus further includes:
a second control module 1106, configured to control the virtual object to move away from the target object.

The display module 1101 is further configured to display the target object pursuing the virtual object when the distance between the virtual object and the target object is less than the distance threshold.

In some embodiments, still referring to FIG. 12, the apparatus further includes:
a third control module 1107, configured to control the virtual object to move away from the target object.

The display module 1101 is further configured to display the target object being converted to the target pollution source when the distance between the virtual object and the target object is greater than or equal to the distance threshold.

In some embodiments, still referring to FIG. 12, the display module 1101 is further configured to display first prompt information in response to a region evolution instruction, the first prompt information being configured for prompting that a region impact value of a polluted region increases with a change amplitude of a distance from a pollution source in the region and that an attribute value of an object corresponding to the pollution source in the polluted region increases.

In some embodiments, still referring to FIG. 12, the display module 1101 is further configured to display the target polluted region as the target purified region when the position of the target object is not in any purified region, a special purified region effect being displayed in the target purified region, and the target purified region being centered around the position of the target object.

In some embodiments, the display module 1101 is further configured to display the special purified region effect in a purified region when the position of the target object is in the purified region.

In some embodiments, still referring to FIG. 12, the position of the target polluted region changes with the movement of the target object.

The apparatus further includes:
a cancellation module 1108, configured to cancel, when the target polluted region covers a center of any purified region, displaying of the purified region.

In some embodiments, still referring to FIG. 12, the apparatus further includes:
an adjustment module 1109, configured to adjust the region impact value of the virtual object based on at least two purified regions when the virtual object enters an overlapping part of the at least two purified regions.

In some embodiments, still referring to FIG. 12, the virtual scene further includes a target battle object. The target battle object is a task objective of the virtual battle.

The region display module 1102 is further configured to remove all remaining objects from the virtual scene when the virtual object defeats the target battle object.

The display module 1101 is further configured to display a special battle ending effect centered around the position of the target battle object.

The apparatus further includes:
an ending module 1110, configured to end the virtual battle.

When the interaction apparatus for a virtual object provided in the foregoing embodiment runs an application program, only division of the foregoing functional modules is used as an example for description. In an actual application, the foregoing functions may be assigned to and completed by different modules as needed, that is, the internal structure of the apparatus is divided into different functional modules to implement all or some of the functions described above. In addition, the interaction apparatus for a virtual object provided in the foregoing embodiment and the embodiment of the interaction method for controlling a virtual object belong to the same idea. For a specific implementation process of the interaction apparatus for a virtual object, reference is made to the method embodiment. Details are not described herein. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

FIG. 13 is a structural block diagram of a terminal 1300 according to an embodiment of this application. The terminal 1300 may be a portable mobile terminal, such as a smartphone, a tablet computer, a player, a notebook computer, or a desktop computer. The terminal 1300 may also be referred to as another name such as a user equipment, a portable terminal, a laptop terminal, or a desktop terminal.

Generally, the terminal 1300 includes a processor 1301 and a memory 1302.

The processor 1301 may include one or more processing cores, such as a 4-core processor and an 8-core processor. The processor 1301 may be implemented by using at least one of the following hardware forms: a digital signal processor (DSP), a field-programmable gate array (FPGA), and a programmable logic array (PLA). The processor 1301 may alternatively include a main processor and a coprocessor. The main processor is configured to process data in a wake-up state, which is also referred to as a central processing unit (CPU). The coprocessor is a low-power processor configured to process data in a standby mode. In some embodiments, the processor 1301 may be have a graphics processing unit (GPU) integrated therein. The GPU is configured to render and draw content that needs to be displayed on a display screen. In some embodiments, the processor 1301 may further include an artificial intelligence (AI) processor. The AI processor is configured to perform computing operations related to machine learning.

The memory 1302 may include one or more computer-readable storage media. The computer-readable storage medium may be non-transitory. The memory 1302 may further include a high-speed random access memory and a non-transitory memory, for example, one or more disk storage devices and flash storage devices. In some embodiments, the non-transitory computer-readable storage media in the memory 1302 are configured to store at least one computer program. The at least one computer program is configured to be executed by the processor 1301 to implement the interaction method for controlling a virtual object provided in the method embodiments of this application.

In some embodiments, the terminal 1300 may include a display screen 1305.

The display screen 1305 is configured to display a user interface (UI). The UI may include a graph, text, an icon, a video, and any combination thereof. When the display screen 1305 is a touch display screen, the display screen 1305 further has a capability of collecting a touch signal on or above a surface of the display screen 1305. The touch signal may be inputted to the processor 1301 as a control signal for processing. In this case, the display screen 1305 may be further configured to provide a virtual button and/or a virtual keyboard, which is also referred to as a soft button and/or a soft keyboard. In some embodiments, one display screen 1305 may be arranged on a front panel of the terminal 1300. In some other embodiments, at least two display screens 1305 may be respectively arranged on different surfaces of the terminal 1300 or in a foldable manner. In still other embodiments, the display screen 1305 may be a flexible display screen arranged on a curved surface or a folded surface of the terminal 1300. The display screen 1305 even may be configured as a non-rectangular irregular pattern, that is, a special-shaped screen. The display screen 1305 may be manufactured by using materials such as a liquid crystal display (LCD) or an organic light-emitting diode (OLED).

A person skilled in the art may understand that the structure shown in FIG. 13 constitutes no limitation on the terminal 1300, and the terminal may include more or fewer components than those shown in the figure, or some merged components, or different component arrangements.

An embodiment of this application further provides a non-transitory computer-readable storage medium. The non-transitory computer-readable storage medium has at least one computer program stored therein. The least one computer program is loaded and executed by a processor of a computer device to implement the operations in the interaction method for controlling a virtual object in the foregoing embodiments performed by the computer device. For example, the non-transitory computer-readable storage medium may be a read-only memory (ROM), a random access memory (RAM), a compact disc read-only memory (CD-ROM), a magnetic tape, a floppy disk, an optical data storage device, or the like.

An embodiment of this application further provides a computer program product or a computer program. The computer program product or the computer program includes computer program code. The computer program code is stored in a computer-readable storage medium. The processor of the computer device reads the computer program code from the computer-readable storage medium, and the processor executes the computer program code, so that the computer device performs the interaction method for controlling a virtual object provided in the foregoing exemplary implementations.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a ROM, a magnetic disk, an optical disc, or the like.

The foregoing descriptions are merely exemplary embodiments of this application, and are not intended to limit this application. Any modification, equivalent replacement, or improvement made within the spirit and principle of this application shall fall within the protection scope of this application.

What is claimed is:

1. An interaction method for controlling a virtual object performed by a computer device, the method comprising:
displaying a virtual scene, the virtual scene comprising a virtual object and a plurality of polluted regions, each of the polluted regions comprising a pollution source at a predefined location within the polluted region;
after the virtual object moves into a target polluted region of the plurality of polluted regions, determining a region impact value of a position of the virtual object based on a distance between the virtual object and the target pollution source;
when the distance between the virtual object and the target pollution source is not greater than a distance threshold, converting the target pollution source into a target object, wherein the target object is movable in the target polluted region; and
when the virtual object defeats the target object, converting the target polluted region into a target purified region and reducing an impact exerted by a current existing pollution source on the target purified region by the region impact value.

2. The method according to claim 1, wherein the target polluted region has an overlapping part with at least one non-target polluted region of the plurality of polluted regions; and
the method further comprises:
determining a first region impact value and at least one second region impact value when the virtual object enters the overlapping part, the first region impact value being determined based on the target polluted region, and the at least one second region impact value being determined based on the at least one non-target polluted region; and
displaying a sum of the first region impact value and the at least one second region impact value as the region impact value of the position of the virtual object.

3. The method according to claim 1, wherein the method further comprises:
performing summation on a battle impact value of the position of the virtual object and the region impact value to obtain an impact sum; and
displaying the impact sum on the virtual scene.

4. The method according to claim 1, wherein the method further comprises:
controlling the virtual object to interact with the target object; and
removing the target object from the virtual scene when a virtual health value of the target object reaches a defeat threshold.

5. The method according to claim 1, wherein the method further comprises:
controlling the virtual object to move away from the target object;
displaying the target object pursuing the virtual object in the target polluted region when the distance between the virtual object and the target object is less than the distance threshold; and
converting the target object back into the target pollution source when the distance between the virtual object and the target object is greater than or equal to the distance threshold.

6. The method according to claim 1, wherein the converting the target polluted region into a target purified region comprises:
when the position of the target object is not in any purified region, displaying a special purified region effect in the target purified region with the position of the target object being a center of the target purified region.

7. The method according to claim 6, wherein the method further comprises:
changing the position of the target polluted region in accordance with the movement of the target object; and
when the target polluted region covers a center of any purified region, canceling the display of the purified region.

8. The method according to claim 6, wherein the method further comprises:
adjusting the region impact value of the position of the virtual object based on at least two purified regions when the virtual object enters an overlapping part of the at least two purified regions.

9. A computer device, comprising a processor and a memory, the memory storing at least one computer program, the at least one computer program being loaded and executed by the processor and causing the computer device to implement an interaction method for controlling a virtual object including:
displaying a virtual scene, the virtual scene comprising a virtual object and a plurality of polluted regions, each of the polluted regions comprising a pollution source at a predefined location within the polluted region;
after the virtual object moves into a target polluted region of the plurality of polluted regions, determining a region impact value of a position of the virtual object based on a distance between the virtual object and the target pollution source;
when the distance between the virtual object and the target pollution source is not greater than a distance threshold, converting the target pollution source into a target object, wherein the target object is movable in the target polluted region; and
when the virtual object defeats the target object, converting the target polluted region into a target purified region and reducing an impact exerted by a current existing pollution source on the target purified region by the region impact value.

10. The computer device according to claim 9, wherein the target polluted region has an overlapping part with at least one non-target polluted region of the plurality of polluted regions; and the method further comprises:
determining a first region impact value and at least one second region impact value when the virtual object enters the overlapping part, the first region impact value being determined based on the target polluted region, and the at least one second region impact value being determined based on the at least one non-target polluted region; and
displaying a sum of the first region impact value and the at least one second region impact value as the region impact value of the position of the virtual object.

11. The computer device according to claim 9, wherein the method further comprises:
performing summation on a battle impact value of the position of the virtual object and the region impact value to obtain an impact sum; and
displaying the impact sum on the virtual scene.

12. The computer device according to claim 9, wherein the method further comprises:
controlling the virtual object to interact with the target object; and
removing the target object from the virtual scene when a virtual health value of the target object reaches a defeat threshold.

13. The computer device according to claim 9, wherein the method further comprises:
controlling the virtual object to move away from the target object;
displaying the target object pursuing the virtual object in the target polluted region when the distance between the virtual object and the target object is less than the distance threshold; and
converting the target object back into the target pollution source when the distance between the virtual object and the target object is greater than or equal to the distance threshold.

14. The computer device according to claim 9, wherein the converting the target polluted region into a target purified region comprises:
when the position of the target object is not in any purified region, displaying a special purified region effect in the target purified region with the position of the target object being a center of the target purified region.

15. The computer device according to claim 14, wherein the method further comprises:
changing the position of the target polluted region in accordance with the movement of the target object; and
when the target polluted region covers a center of any purified region, canceling the display of the purified region.

16. The computer device according to claim 14, wherein the method further comprises:
adjusting the region impact value of the position of the virtual object based on at least two purified regions when the virtual object enters an overlapping part of the at least two purified regions.

17. A non-transitory computer-readable storage medium storing at least one computer program, the at least one computer program being loaded and executed by a processor of a computer device and causing the computer device to implement an interaction method for controlling a virtual object including:
displaying a virtual scene, the virtual scene comprising a virtual object and a plurality of polluted regions, each of the polluted regions comprising a pollution source at a predefined location within the polluted region;
after the virtual object moves into a target polluted region of the plurality of polluted regions, determining a region impact value of a position of the virtual object based on a distance between the virtual object and the target pollution source;
when the distance between the virtual object and the target pollution source is not greater than a distance threshold, converting the target pollution source into a target object, wherein the target object is movable in the target polluted region; and
when the virtual object defeats the target object, converting the target polluted region into a target purified region and reducing an impact exerted by a current existing pollution source on the target purified region by the region impact value.

18. The non-transitory computer-readable storage medium according to claim 17, wherein the target polluted region has an overlapping part with at least one non-target polluted region of the plurality of polluted regions; and the method further comprises:
determining a first region impact value and at least one second region impact value when the virtual object enters the overlapping part, the first region impact value being determined based on the target polluted region, and the at least one second region impact value being determined based on the at least one non-target polluted region; and
displaying a sum of the first region impact value and the at least one second region impact value as the region impact value of the position of the virtual object.

19. The non-transitory computer-readable storage medium according to claim 17, wherein the method further comprises:
controlling the virtual object to move away from the target object;
displaying the target object pursuing the virtual object in the target polluted region when the distance between the virtual object and the target object is less than the distance threshold; and
converting the target object back into the target pollution source when the distance between the virtual object and the target object is greater than or equal to the distance threshold.

20. The non-transitory computer-readable storage medium according to claim 17, wherein the converting the target polluted region into a target purified region comprises:
when the position of the target object is not in any purified region, displaying a special purified region effect in the target purified region with the position of the target object being a center of the target purified region.
